(19) United States
(12) Patent Application Publication
(10) Pub. No.: US 2008/0185981 A1
(43) Pub. Date: Aug. 7, 2008

(54) Ignitor Disconnection Control System and Method

(75) Inventors: Ernesto Mendoza, Elgin, IL (US); Kevin Pasquarelli, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,008

(22) PCT Filed: Feb. 9, 2006
(86) PCT No.: PCT/IB06/50430

§ 371 Date: Aug. 10, 2007

Related U.S. Application Data
(60) Provisional application No. 60/651,938, filed on Feb. 10, 2005.

(51) Int. Cl. H05B 41/04

(52) U.S. Cl. 315/309; 315/291

(57) ABSTRACT

An ignitor disconnection control system and method includes an ignitor having a semi-conductor switch (58) and capacitor (60) connected in series to form a junction (70) between the semi-conductor switch (58) and the capacitor (60), and a series circuit (68) connected between the junction (70) and common (32). The series circuit (68) has an inductor (62), a resistor (64), and a positive thermal change (PTC) resistor (66) connected in series, with the resistor (64) thermally coupled to the PTC resistor (66).

This invention relates generally to lamp operating circuits, and more specifically to lamp ignitors with disconnection control.

Many high intensity discharge lamps require high voltage pulses to start the lamp. An ignitor in the lamp operating circuit provides the high voltage pulses, which are typically about 4 to 5 kVolts peak. Once the lamp ignites, the voltage to the ignitor is reduced and the ignitor ceases to supply the high voltage pulses.

Problems arise, however, when the lamp is missing or broken. The lamp operating circuit will continuously attempt to light the faulty lamp, with the ignitor continuing to provide high voltage pulses at the lamp connection. Continuous exposure of the lamp operating circuit and the lamp connection to the high voltage pulses can result in insulation breakdown and premature failure of lamp components. In addition, maintenance personnel can be exposed to the high voltage pulses should they improperly attempt to replace the lamp or work on the lamp operating circuit without disconnecting power to the lamp operating circuit.

Previous attempts have been made to automatically disconnect the ignitor when the lamp is defective or fails to start. Attempts have included adding disconnection circuits with numerous components and complicated circuits. Such disconnection circuits increase the cost of the lamp operating circuits and increase the chance of circuit failure.

It would be desirable to have an ignitor disconnection control system and method that overcomes the above disadvantages.

One aspect of the present invention provides an ignitor having a semi-conductor switch and capacitor connected in series to form a junction between the semi-conductor switch and the capacitor, and a series circuit connected between the junction and common. The series circuit has an inductor, a resistor, and a positive thermal change (PTC) resistor connected in series, with the resistor thermally coupled to the PTC resistor.

Another aspect of the present invention provides a method for ignitor disconnection control including providing an ignitor having a resistor and a positive thermal change (PTC) resistor, heating the resistor with ignitor current, monitoring temperature of the resistor with the PTC resistor, and disconnecting the ignitor when the temperature exceeds a trigger temperature of the PTC resistor.

Another aspect of the present invention provides a system for ignitor disconnection control including an ignitor having a resistor, means for heating the resistor with ignitor current, means for monitoring temperature of the resistor, and means for disconnecting the ignitor when the temperature exceeds a trigger temperature.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

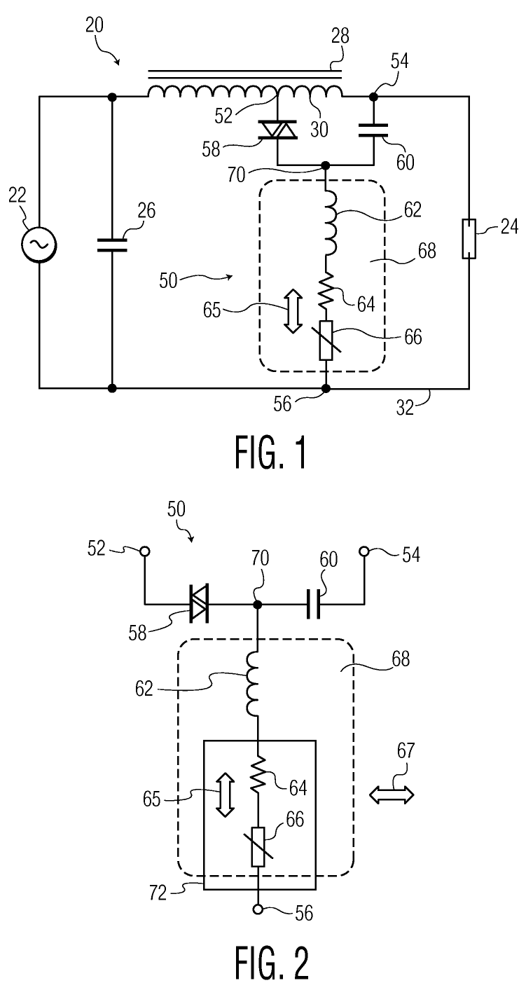

FIG. 1 is a schematic diagram of a lamp operating circuit including an ignitor with a disconnection control system made in accordance with the present invention;

FIG. 2 is a schematic diagram of an ignitor with a disconnection control system made in accordance with the present invention; and

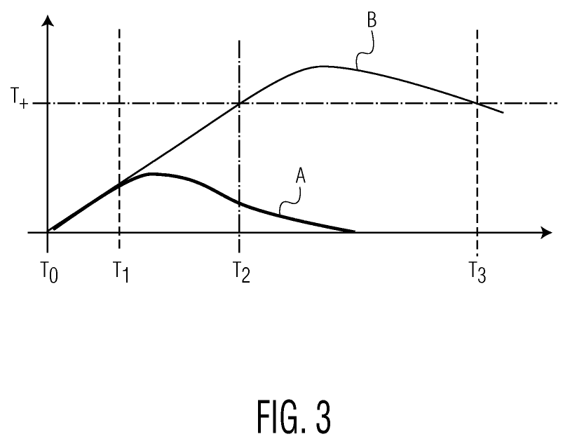

FIG. 3 is a graph of temperature versus time for an ignitor with a disconnection control system made in accordance with the present invention.

FIG. 1 is a schematic diagram of a lamp operating circuit including an ignitor with a disconnection control system made in accordance with the present invention. Exemplary lamp operating circuit 20 receives mains power 22 to ignite and supply power to lamp 24. The lamp 24 requires a relatively high voltage pulse in order to be ignited, e.g., 2.5-4 kVolts, and thereafter operates on a much lower voltage, such as 95-105 Volts. The mains power 22 is connected in parallel across power factor capacitor 26 and ballast inductor 28 is connected in series with the lamp 24. The ballast inductor 28 provides current limiting impedance. An ignitor 50 is a three lead ignitor with lead 52 and lead 54 connected across portion 30 of the ballast inductor 28, and a lead 56 connected to common 32.

The ignitor 50 includes a normally open, bidirectionally conductive semi-conductor switch 58 and capacitor 60 connected in series between the lead 52 and the lead 54 to form a junction 70 between the semi-conductor switch 58 and the capacitor 60. A series circuit 68 having an inductor 62, a resistor 64, and a positive thermal change (PTC) resistor 66 is connected between the junction 70 and the lead 56. The resistor 64 is thermally coupled to the PTC resistor 66 as indicated by arrow 65. The PTC resistor 66 provides a minimal resistance below a trigger temperature and provides a high resistance above the trigger temperature.

In order to generate high voltage starting pulses for the lamp 24, the ballast inductor 28 is connected as a step-up autotransformer. Before ignition, the lamp 24 presents an open circuit to the autotransformer. When power is applied initially, the capacitor 60 will begin to charge with ignitor current via the ballast inductor 28, inductor 62, resistor 64, and PTC resistor 66. The rate of charge of the capacitor 60 is governed by the time constant of this circuit.

When the capacitor voltage reaches the predetermined threshold or breakdown voltage of the semi-conductor switch 58, the semi-conductor switch 58 closes to allow the capacitor 60 to discharge through the portion 30 of the ballast inductor 28. The primary voltage is stepped up by the transformation ratio of the autotransformer to produce a pulse voltage across the entire winding of sufficient amplitude to ignite the discharge lamp 24. The high voltage pulse generated is superimposed upon the 60 Hz AC waveform supplied from mains power 22 and is arranged to occur near the peak of the AC supply voltage waveform.

In normal operation, the lamp 24 becomes conductive after the lamp ignites. The output voltage of the ballast inductor 28 is limited to the operating voltage of the lamp 24, which is considerably lower than the lamp ignition voltage. As a result, the capacitor 60 will no longer charge up to a voltage value sufficient to fire the semi-conductor switch 58, and the semi-conductor switch 58 remains in its open circuit condition while the lamp 24 is conductive. This effectively removes the starting circuit from the lamp operating circuit 20 so that further ignition pulses are inhibited during the time that the lamp is in operation (conductive). The ballast inductor 28 provides the lamp ballast function during normal operation as is conventional in discharge lamp circuits.

Should the lamp 24 fail to ignite due to a faulty or missing lamp, the ignitor 50 disconnects itself from the lamp operating circuit 20. The ignitor 50 attempts to start the lamp 24 with repeated high voltage pulses, heating the resistor 64 while repeatedly charging the capacitor 60. When the temperature of the resistor 64 raises the temperature of the thermally coupled PTC resistor 66 to the trigger temperature of the PTC resistor 66, the resistance of the PTC resistor 66 increases to a high resistance. This prevents further charging of the capacitor 60 by the ignitor current, ending the high voltage pulses and disconnecting the ignitor 50 from the lamp operating circuit 20. The ignitor 50 remains disconnected until the temperature of the PTC resistor 66 falls below the trigger temperature, at which time the ignitor 50 can again attempt to ignite the lamp 24.

Those skilled in the art will appreciate that the lamp operating circuit 20 discussed above is but an example of the type of lamp operating circuit that can be used with the ignitor of the present invention. The ignitor 50 can be used with different types of lamp operating circuits as desired for a particular application.

FIG. 2, in which like elements share like reference numbers with FIG. 1, is a schematic diagram of an ignitor with a disconnection control system made in accordance with the present invention. The resistor 64 is thermally coupled to the PTC resistor 66 as indicated by arrow 65 to disconnect the ignitor 50 from the lamp operating circuit should the lamp be missing or fail to start. The ignitor 50 includes a semi-conductor switch 58 and capacitor 60 connected in series between the lead 52 and the lead 54 to form a junction 70 between the semi-conductor switch 58 and the capacitor 60. A series circuit 68 having an inductor 62, a resistor 64, and a positive thermal change (PTC) resistor 66 is connected between the junction 70 and the lead 56.

During startup, the capacitor 60 charges through the ballast inductor (not shown) and the series circuit 68. Ignitor current passes through the inductor 62, resistor 64, and PTC resistor 66, heating the resistor 64. The ignitor 50 generates a high voltage pulse when the voltage across the capacitor 60 exceeds the breakdown voltage of the semi-conductor switch 58. When the lamp is operating normally, the charging and breakdown cycle continues generating high voltage pulses until the lamp starts. When the lamp is faulty or missing, the charging and breakdown cycle continues for a longer time, heating the resistor 64 to a higher temperature.

When the temperature of the resistor 64 raises the temperature of the thermally coupled PTC resistor 66 to the trigger temperature of the PTC resistor 66 at a predetermined heating time, the resistance of the PTC resistor 66 increases to a high resistance. This reduces the ignitor current and the voltage across the capacitor 60, preventing the capacitor 60 from charging to the breakdown voltage of the semi-conductor switch 58. The ignitor 50 is disconnected from the lamp operating circuit and ceases generating high voltage pulses. The thermal inertia of the resistor 64 causes a temperature lag between the temperature at the resistor 64 and sensed temperature at the PTC resistor 66, assuring that the ignitor 50 will not reconnect immediately on disconnection and cause an unstable condition.

After the ignitor 50 is disconnected, the temperature of the resistor 64 decreases for a predetermined cooling time as the ignitor 50 transfers heat to the atmosphere and surrounding lamp operating system components as indicated by arrow 67. When the temperature of the thermally coupled PTC resistor 66 falls below the trigger temperature of the PTC resistor 66, the resistance of the PTC resistor decreases to the minimal resistance. The ignitor 50 is reconnected and, providing mains power is present, returns to generating high voltage pulses to again attempt to ignite the lamp.

The thermal coupling of the resistor 64 to the PTC resistor 66, and the resistor 64 to the atmosphere can be designed to provide the desired timing for disconnecting and reconnecting the ignitor 50. In one embodiment, the resistor 64 is in contact but not attached to the PTC resistor 66. In an alternative embodiment, the resistor 64 is connected to the PTC resistor 66 with a thermally conductive adhesive, the thermal conductivity being selected to provide the desired time lag between the temperature of the resistor 64 and the sensed temperature at the PTC resistor 66. Examples of adhesives include epoxy, polyester, and the like. In another alternative embodiment, the resistor 64 and the PTC resistor 66 are potted in a thermally conductive fill material, which can also be electrically insulating. Examples of fill material include epoxy, PolyFill, polyester, and the like. An optional enclosure 72 can be used to contain the fill material and facilitate manufacture when the fill material is initially a liquid and hardens to a solid. The enclosure 72 can also include heat transfer features to facilitate or impede heat transfer from the enclosure 72 to the atmosphere. Examples of heat transfer features include heat transfer fins and insulation. In another alternative embodiment, the semi-conductor switch 58, the capacitor 60, and the inductor 62 are also potted with the resistor 64 and the PTC resistor 66, so that all the components of the ignitor 50 are potted together. The leads 52, 54, and 56 can be exposed from the fill material as connection prongs to make the ignitor 50 a plug-in, modular unit. The ignitor 50 can include an exterior enclosure (not shown) similar to the enclosure 72 discussed above and disposed about all the components, with heat transfer features as desired.

The semi-conductor switch 58 can be any suitable switch that changes from non-conducting to conducting when a desired breakdown voltage is applied. Examples of suitable semi-conductor switches include thyristors, silicon-controlled rectifiers (SCRs), triacs, diacs, sidacs, four layer diodes, and the like.

The PTC resistor 66 can be any suitable resistor that provides minimal resistance below a trigger temperature and a high resistance above the trigger temperature, and that allows thermal coupling to the resistor 64. The minimal resistance is typically on the order of tens or hundreds of ohms and the high resistance is typically two to three orders of magnitude greater than the minimal resistance. Typical trigger temperatures are between about 55 and 75 degrees Celsius. PTC resistors are also known as positive temperature change thermistors. PTC resistors are available in different package styles, such as disc, transistor, glass, and molded. The package type can be selected to conform to the shape of the resistor 64. In one embodiment, the PTC resistor 66 is a disc style allowing contact with the side of two adjacent cylindrical resistors forming the resistor 64. In an alternative embodiment, the PTC resistor 66 is a molded cylindrical style allowing contact between two adjacent cylindrical resistors forming the resistor 64. Those skilled in the art will appreciate that a number of shapes for the PTC resistor 66 and resistor 64 are suitable for particular applications.

The resistor 64 can be one or more suitable resistor having the desired electrical resistance and heat capacity. In alternate embodiments, a 5.7k Ohm resistor of 1, 5, or 10 Watts is used to provide the physical size for the desired heat capacity.

The operating and physical parameters of the ignitor 50 are selected to provide the desired predetermined heating time until disconnect and predetermined cooling time until reconnect. The electrical resistance of the resistor 64 affects the power generated in the resistor 64 and the time to heat up to the trigger temperature of the PTC resistor 66. The physical size of the resistor 64 determines the heat capacity of the resistor 64, which affects the time to heat up to the trigger temperature of the PTC resistor 66 before disconnection and the time to cool down to the trigger temperature of the PTC resistor 66 after disconnection. The trigger temperature of the PTC resistor 66 affects how much heat is stored in the resistor 64 and any fill material before disconnection. The degree of thermal coupling between the resistor 64 and the PTC resistor 66 affects how quickly the trigger temperature of the PTC resistor 66 is reached as the resistor 64 and any fill material heats or cools. The degree of thermal coupling of the resistor 64 and any fill material with the atmosphere affects how quickly the trigger temperature of the PTC resistor 66 is reached after disconnection. Those skilled in the art will appreciate that the operating and physical parameters of the ignitor 50 interact and can be selected to suit any application desired.

In one embodiment, the semi-conductor switch 58 switches at 240-265 Volts and the capacitor 60 is 0.15 microfarads. The PTC resistor 66 has a trigger temperature of 60 degrees Celsius. The resistor 64 has a resistance of 5.5k Ohms and a physical size of 23.1 millimeters long and 7.5 millimeters in diameter. Fill material of PolyFill 300 Polyester Electrical Encapsulating and Potting Compound available from The P. D. George Company of St. Louis, Mo., USA, is used to pot the components of the ignitor 50 within an enclosure leaving the terminals 52, 54, and 56 exposed to provide electrical connection.

FIG. 3 is a graph of temperature versus time for an ignitor with a disconnection control system made in accordance with the present invention. The PTC resistor monitors temperature of the resistor until the trigger temperature is reached, when the PTC resistor disconnects the ignitor. The ignitor remains disconnected until the PTC resistor cools below the trigger temperature.

At time t₀, voltage is applied to the lamp operating circuit. The ignitor generates high voltage pulses at the lamp to ignite the lamp. Ignitor current passes through and heats the resistor thermally coupled to the PTC resistor. Curve A of FIG. 3 illustrates the temperature at the PTC resistor for a properly operating lamp. When the lamp is operating properly, the lamp ignites after a few high voltage pulses at time t₁, the ignitor stops generating high voltage pulses, the resistor cools, and the PTC resistor remains below the trigger temperature Tₜ.

Curve B of FIG. 3 illustrates the temperature at the PTC resistor for a faulty lamp, i.e., a lamp that fails to start or is missing. When the lamp is faulty, the lamp fails to ignite and the ignitor current heats the resistor as the PTC resistor monitors the temperature of the resistor. When the temperature at the PTC resistor reaches the trigger temperature Tₜ at time t₂, the resistance of the PTC resistor increases to the high resistance, reducing ignitor current and the voltage across the capacitor, disconnecting the ignitor. The temperature at the PTC resistor continues to rise for a short time after the ignitor is disconnected at t₂, as the stored heat leaves the resistor. The thermal inertia of the resistor assures that the ignitor will not reconnect quickly and cause an unstable situation. The temperature at the PTC resistor falls as the ignitor, including the resistor and any fill material, transfers heat to the atmosphere and surrounding lamp operating system components. When the temperature at the PTC resistor falls below the trigger temperature at time t₃, the resistance of the PTC resistor decreases to the minimal resistance, increasing the voltage across the semi-conductor switch and reconnecting the ignitor. The lamp will attempt to ignite when voltage is still being applied to the lamp operating circuit.

The predetermined heating time from t₀ to t₂ and the predetermined cooling time from t₂ to t₃ are determined by the selection of the operating and physical parameters of the ignitor as discussed in conjunction with FIG. 2 above. In one embodiment, the predetermined heating time is between about 5 and 30 minutes, such as 5, 15, or 30 minutes. In another embodiment, the predetermined cooling time is between about 20 and 60 minutes, such as 30 minutes.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. An ignitor comprising:
a semi-conductor switch 58 and capacitor 60 connected in series to form a junction 70 between the semi-conductor switch 58 and the capacitor 60; and
a series circuit 68 connected between the junction 70 and common 32, the series circuit 68 having an inductor 62, a resistor 64, and a positive thermal change (PTC) resistor 66 connected in series;
wherein the resistor 64 is thermally coupled to the PTC resistor 66.

2. The ignitor of claim 1 wherein semi-conductor switch 58 is selected from the group consisting of thyristors, silicon-controlled rectifiers (SCRs), triacs, diacs, sidacs, and four layer diodes.

3. The ignitor of claim 1 wherein the resistor 64 is connected to the PTC resistor 66 with an adhesive.

4. The ignitor of claim 3 wherein the adhesive is selected from the group consisting of epoxy and polyester.

5. The ignitor of claim 3 wherein the adhesive provides a desired time lag between temperature of the resistor 64 and sensed temperature at the PTC resistor 66.

6. The ignitor of claim 1 wherein the resistor 64 is potted with the PTC resistor 66 in a fill material.

7. The ignitor of claim 6 wherein the fill material is selected from the group consisting of epoxy, PolyFill, and polyester.

8. The ignitor of claim 6 wherein the semi-conductor switch 58, the capacitor 60, and the inductor 62 are also potted with the PTC resistor 66.

9. The ignitor of claim 6 further comprising an enclosure 72 disposed about the fill material, the enclosure 72 having heat transfer features.

10. The ignitor of claim 6 wherein the fill material provides a desired time lag between temperature of the resistor 64 and sensed temperature at the PTC resistor 66.

11. The ignitor of claim 6 wherein the fill material provides a desired time lag between temperature of the resistor 64 and sensed temperature at the PTC resistor 66.

12. The ignitor of claim 6 wherein the fill material provides a predetermined heating time.

13. The ignitor of claim 12 wherein the predetermined heating time is between 5 and 30 minutes.

14. The ignitor of claim 6 wherein the fill material provides a predetermined cooling time.

15. The ignitor of claim 14 wherein the predetermined cooling time is between 20 and 60 minutes.

16. The ignitor of claim 1 wherein the PTC resistor 66 has a trigger temperature between 55 and 75 degrees Celsius.

17. A method for ignitor disconnection control comprising:
providing an ignitor having a resistor and a positive thermal change (PTC) resistor;
heating the resistor with ignitor current;
monitoring temperature of the resistor with the PTC resistor; and
disconnecting the ignitor when the temperature exceeds a trigger temperature of the PTC resistor.

18. The method of claim 17 further comprising:
cooling the resistor; and
reconnecting the ignitor when the temperature falls below the trigger temperature of the PTC resistor.

19. The method of claim 18 wherein the cooling comprises cooling the resistor for a predetermined cooling time until the temperature falls below the trigger temperature of the PTC resistor.

20. The method of claim 17 wherein the heating comprises heating the resistor for a predetermined heating time until the temperature exceeds the trigger temperature of the PTC resistor.

21. The method of claim 17 wherein the disconnecting comprises increasing resistance of the PTC resistor to decrease the ignitor current.

22. A system for ignitor disconnection control comprising:
an ignitor having a resistor;
means for heating the resistor with ignitor current;
means for monitoring temperature of the resistor; and
means for disconnecting the ignitor when the temperature exceeds a trigger temperature.

23. The system of claim 22 further comprising:
means for cooling the resistor; and
means for reconnecting the ignitor when the temperature falls below the trigger temperature.

24. The system of claim 23 wherein the means for cooling comprises means for cooling the resistor for a predetermined cooling time until the temperature falls below the trigger temperature.

25. The system of claim 22 wherein the means for heating comprises means for heating the resistor for a predetermined heating time until the temperature exceeds the trigger temperature.

26. The system of claim 22 wherein the means for disconnecting comprises means for decreasing the ignitor current.
